(19) United States
(12) Patent Application Publication
(10) Pub. No.: US 2007/0231920 A1
(43) Pub. Date: Oct. 4, 2007

(54) Method of determining chelating agent and determination kit for chelating agent

(75) Inventor: Hiroyuki Mitsumoto, Matsuyama-shi (JP)

Correspondence Address: BIRCH STEWART KOLASCH & BIRCH, PO BOX 747, FALLS CHURCH, VA, 22040-0747, US

(73) Assignee: Miura Co., Ltd.

(21) Appl. No.: 11/727,130

(22) Filed: Mar. 23, 2007

(30) Foreign Application Priority Data
Mar. 28, 2006 (JP) 2006-868634

(51) Int. Cl. G01N 31/16

(52) U.S. Cl. 436/163

(57) ABSTRACT

The concentration of a water treating agent can be simply understood on site where thermal equipment is placed. A method of determining a chelating agent according to the present invention includes the steps of: collecting a water sample; adding a first chemical solution containing a metal indicator and a second chemical solution containing a pH adjuster to the collected water sample, respectively; dropping a third chemical solution which contains a metal salt that causes a change in color of the metal indicator into the water sample added with the first chemical solution and the second chemical solution, followed by counting the number of droplets required for the water sample to change color thereof; and determining a concentration of a chelating agent in the water sample on the basis of the number of droplets of the third chemical solution. A kit for determining a chelating agent according to the present invention includes: a first container that reserves a first chemical solution containing a metal indicator; a second container that reserves a second chemical solution containing a pH adjuster; and a third container that reserves a third chemical solution containing a metal salt that causes a change in color of the metal indicator.

### BACKGROUND OF THE INVENTION

1. Field of the Invention

The present invention relates to a method of determining a chelating agent and a determination kit for a chelating agent, particularly to a determination method of simply determining a concentration of a chelating agent in water added with a water treating agent and a determination kit for the method.

2. Description of the Related Art

In thermal equipment such as a boiler or a cooling tower, for preventing water from causing corrosion or scale formation on a heat-transfer surface, water treating agents have generally been added to water to be supplied. In recent years, in the boiler, water treating agents made of food additives containing silica, an alkaline agent, and a scale inhibitor have been used, as described in JP 2003-159597 A. Here, the silica is blended so that it forms a coating on the heat-transfer surface of the boiler to protect the surface from corrosion by water. In addition, the alkaline agent is typically an alkali metal hydroxide, which is blended for adjusting water to a pH range of 11 to 12 to make the heat-transfer surface difficult to be corroded. Further, the scale inhibitor is a chelating agent, which is capable of forming a complex with any of hardness components (calcium and magnesium ions) each of which is a scale-promoting component, a copper ion, a zinc ion, an iron ion, and the like in water to be supplied. The scale inhibitor is blended for preventing the scale formation on the interface between the heat-transfer substance and the water.

The supply amount of the water treating agent is determined so that the concentration of the water treating agent in the thermal equipment is within a given range on the basis of the quality of water to be supplied and the operating conditions of the thermal equipment (i.e., the concentration rate of the water treating agent in the boiler). For exerting the effect of the water treating agent at maximum, it is important to keep the concentration of the water treating agent within a predetermined range. The supply amount of a water treating agent should be quickly readjusted when the concentration of the water treating agent is insufficient or overabundant. For those reasons, it is essential for a maintainer or a user to periodically understand the concentration of a water treating agent in the thermal equipment on site where the thermal equipment is placed.

To obtain the concentration of a water treating agent, it will require a great deal of time and efforts to individually determine all of components to be supplied in the water treating agent in a quantitative manner. In addition, to determine a specific component to be supplied in the water treating agent in a quantitative manner, for example, in the case of the water treating agent disclosed in JP 2003-159597 A, there is a problem in that the concentration of the component calculated from the supply amount thereof does not correspond to the actual concentration thereof. This is because silica forms a coating on the heat-transfer surface. Further, an alkali metal hydroxide is generated when an alkaline component such as sodium hydrogen carbonate in water to be supplied is thermally decomposed. Therefore, particularly in the boiler, there is also a problem in that the concentration of the component calculated from the supply amount thereof does not correspond to the actual concentration thereof. For the reasons, there has been a situation in which the concentration of a water treating agent can not simply be understood on the site where the thermal equipment is placed.

### SUMMARY OF THE INVENTION

The present invention has been made in view of the above-mentioned circumstances, and an object of the invention is to provide a method with which a concentration of a water treating agent can be simply understood on site where thermal equipment is placed.

The present invention has been made to solve the above-mentioned problems. According to a first aspect of the present invention, there is provided a method of determining a concentration of a chelating agent in a water sample, including the steps of: collecting a water sample; adding a first chemical solution containing a metal indicator and a second chemical solution containing a pH adjuster to the collected water sample, respectively; dropping a third chemical solution which contains a metal salt that causes a change in color of the metal indicator into the water sample added with the first chemical solution and the second chemical solution, followed by counting the number of droplets required for the water sample to change color thereof; and determining a concentration of a chelating agent in the water sample on the basis of the number of droplets of the third chemical solution.

According to the first aspect of the present invention, the chelating agent dominantly forms a complex with a specific metal ion from the metal salt when the third chemical solution is gradually dropped into the water sample added with both the first and second chemical solutions. Once the whole amount of the chelating agent is complexed with the specific metal ion, then the metal indicator is allowed to complex with the redundant specific metal ion, thereby causing a change in color of the water sample. The supply amount of the specific metal ion that changes the color of a water sample corresponds to the amount of the chelating agent present in the water sample, so the concentration of the chelating agent can be determined on the basis of the number of dropped droplets of the third chemical solution. Consequently, the present determination method allows a maintainer or a user to simply understand the concentration of a water treating agent in thermal equipment using the chelating agent in the water treating agent as an indicator.

According to a second aspect of the present invention, the method according to the first aspect of the present invention further includes the step of adding a masking agent to the collected water sample.

According to the second aspect of the present invention, when the third chemical solution is gradually dropped into the water sample in the presence of the masking agent, ferrous and copper ions being complexed with the chelating agent are dominantly complexed with the masking agent. Therefore, the whole amount of the chelating agent can be quickly complexed with the specific metal ion and a reaction time required for the water sample to change its color can then be shortened. Consequently, the present determination method allows a maintainer or a user to quickly and accurately understand the concentration of a water treating agent in thermal equipment using the chelating agent in the water treating agent as an indicator.

According to a third aspect of the present invention, the method according to the second aspect of the present invention further includes the step of adding a reducing agent to the collected water sample.

According to the third aspect of the present invention, the addition of the reducing agent allows a ferric ion to be reduced to a ferrous ion in the water sample. Then, the masking agent encloses the ferrous ion. Therefore, the development of color which is caused by the formation of a complex with the ferric ion can be prevented, so the water sample can retain its normal hue. Consequently, the present determination method allows a maintainer or a user to more accurately understand the concentration of a water treating agent in thermal equipment using the chelating agent in the water treating agent as an indicator.

According to a fourth aspect of the present invention, there is provided a method of determining a concentration of a chelating agent in a water sample, including the steps of: collecting a water sample; adding a first chemical solution containing a metal indicator and a second chemical solution containing a pH adjuster to the collected water sample, respectively; dropping a third chemical solution which contains a metal salt that causes a change in color of the metal indicator into the water sample added with the first chemical solution and the second chemical solution, followed by counting the number of droplets required for the water sample to change color thereof; and determining a concentration of a chelating agent in the water sample on the basis of the number of droplets of the third chemical solution, in which the chelating agent is at least one of ethylene diamine tetraacetic acid and a salt thereof, the metal indicator is xylenol orange, the pH adjuster is nitric acid, and the metal salt is bismuth nitrate.

According to the forth aspect of the present invention, when the third chemical solution is gradually dropped into the water sample added with both the first and second chemical solutions, ethylene diamine tetraacetic acid (EDTA) dominantly forms a complex with a bismuth ion from bismuth nitrate. Subsequently, when the whole amount of EDTA is complexed with the bismuth ion, xylenol orange is then complexed with the redundant bismuth ion, thereby causing a change in color of the water sample. The supply amount of the bismuth ion that changes the color of a water sample corresponds to the amount of EDTA present in the water sample, so the concentration of EDTA can be determined on the basis of the number of dropped droplets of the third chemical solution. Consequently, the present determination method allows a maintainer or a user to simply understand the concentration of a water treating agent in thermal equipment using the EDTA in the water treating agent as an indicator.

According to a fifth aspect of the present invention, the method according to the fourth aspect of the present invention further includes the step of adding a masking agent to the collected water sample, in which the masking agent is o-phenanthroline.

According to the fifth aspect of the present invention, when the third chemical solution is gradually dropped into the water sample in the presence of o-phenanthroline, ferrous and copper ions being complexed with EDTA are dominantly complexed with o-phenanthroline. Therefore, the whole amount of EDTA can be quickly complexed with a bismuth ion and a reaction time required for the water sample to change its color can then be shortened. Consequently, the present determination method allows a maintainer or a user to quickly and accurately understand the concentration of a water treating agent in thermal equipment using the EDTA in the water treating agent as an indicator According to a sixth aspect of the present invention, the method according to the fifth aspect of the present invention further includes the step of adding a reducing agent to the collected water sample, in which the reducing agent is at least one of ascorbic acid and an alkaline metal salt thereof.

According to the sixth aspect of the present invention, the addition of ascorbic acid or an alkali metal salt allows a ferric ion to be reduced to a ferrous ion in the water sample. Then, o-phenanthroline encloses the ferrous ion. Therefore, the development of color which is caused by the formation of a complex with the ferric ion can be prevented, so the water sample can retain its normal hue. Consequently, the present determination method allows a maintainer or a user to more accurately understand the concentration of a water treating agent in thermal equipment using the EDTA in the water treating agent as an indicator.

According to a seventh aspect of the present invention, there is provided a kit for quantitatively determining a concentration of a chelating agent in a water sample, including: a first container that reserves a first chemical solution containing a metal indicator; a second container that reserves a second chemical solution containing a pH adjuster; and a third container that reserves a third chemical solution containing a metal salt that causes a change in color of the metal indicator.

According to the seventh aspect of the present invention, after the addition of the second chemical solution from the second container as well as the addition of the first chemical solution from the first container to the water sample, the third chemical solution is gradually dropped from the third container into the water sample, thereby allowing the chelating agent to dominantly form a complex with a specific metal ion from the metal salt. When the whole amount of the chelating agent is complexed with the specific metal ion, the metal indicator is complexed with the redundant specific metal ion, thereby causing a change in color of the water sample. The supply amount of the specific metal ion that changes the color of a water sample corresponds to the amount of the chelating agent present in the water sample, so the concentration of the chelating agent can be determined on the basis of the number of dropped droplets of the third chemical solution. Consequently, the present determination kit allows a maintainer or a user to simply understand the concentration of a water treating agent in the thermal equipment using the chelating agent in the water treating agent as an indicator.

According to an eighth aspect of the present invention, in the seventh aspect of the present invention, any one of the first chemical solution and the second chemical solution further contains a masking agent.

According to the eighth aspect of the present invention, after the addition of the masking agent to the water sample via any one of the first and second chemical solutions, the third chemical solution is gradually added to the water sample, thereby allowing ferrous and copper ions being complexed with the chelating gent to be dominantly complexed with the masking agent. Therefore, the whole amount of the chelating agent can be quickly complexed with the specific metal ion and a reaction time required for the water sample to change its color can then be shortened. Consequently, the present determination kit allows a maintainer or a user to quickly and accurately understand the concentration of a water treating agent in thermal equipment using the chelating agent in the water treating agent as an indicator.

According to a ninth aspect of the present invention, in the eighth aspect of the present invention, the first chemical solution further contains a reducing agent.

According to the ninth aspect of the present invention, the addition of the reducing agent via the first chemical solution allows a ferric ion to be reduced to a ferrous ion in the water sample. Then, the masking agent encloses the ferrous ion. Therefore, the development of color which is caused by the formation of a complex with the ferric ion can be prevented, so the water sample can retain its normal hue. Consequently, the present determination kit allows a maintainer or a user to more accurately understand the concentration of a water treating agent in thermal equipment using the chelating agent in the water treating agent as an indicator.

According to a tenth aspect of the present invention, the kit according to the eighth aspect of the present invention further includes a fourth container that reserves a powdery reducing agent.

According to the tenth aspect of the present invention, the addition of the powdery reducing agent from the fourth container allows a ferric ion to be reduced to a ferrous ion in the water sample. Then, the masking agent encloses the ferrous ion. Therefore, the development of color which is caused by the formation of a complex with the ferric ion can be prevented, so the water sample can retain its normal hue. Consequently, the present determination kit allows a maintainer or a user to more accurately understand the concentration of a water treating agent in the thermal equipment using the chelating agent in the water treating agent as an indicator.

According to the present invention, the concentration of a water treating agent can be simply understood on site where thermal equipment is placed. Accordingly, it is possible to quickly judge whether the supply amount of the water treating agent to the thermal equipment is suitable at the site, so maintenance for water treatment can be made more efficient.

### BRIEF DESCRIPTION OF THE DRAWING

FIG. 1 is a graph showing a correlation between a quantitative value of EDTA-2Na obtained by the HPLC method and a quantitative value of EDTA-2Na obtained by simplified titrimetry.

### DETAILED DESCRIPTION OF THE PREFERRED EMBODIMENTS

Hereinafter, embodiments of the present invention will be described in detail. The determination method and the determination kit of the present invention are utilized for managing a supply amount of a water treating agent to be supplied to thermal equipment as represented by a boiler or a cooling tower. Specifically, the chelating agent in the water treating agent is used as a tracer to determine the concentration of the water treating agent in the thermal equipment. On the basis of the concentration of the water treating agent, the chelating agent is utilized for judging whether the supply amount of the water treating agent is suitable.

In the water treating agent, the chelating agents are blended for enclosing any of hardness components (calcium and magnesium ions) each of which is a scale-promoting component, a copper ion, a zinc ion, an iron ion, and the like in water and for preventing the scale formation on the heat-transfer surface of the thermal equipment. Examples of the chelating agents which are used include organic aminocarboxylic acid-based compounds and tricarboxylic acid-based compounds and inorganic polymerized phosphate-based compounds.

Specific examples of the aminocarboxylic acid-based compounds include: ethylene diamine tetraacetic acid (EDTA) and a salt thereof; nitrilotriacetic acid (NTA) and a salt thereof; hydroxyethyl ethylene diamine triacetic acid (HEDTA) and a salt thereof; and trans-1,2-diaminocyclohexane tetraacetic acid (CyDTA) and a salt thereof. In addition, specific examples of the tricarboxylic acid-based compounds include citric acid and a salt thereof. Further, specific examples of the polymerized phosphate-based compounds include hydroxyethylidene diphosphonic acid (HEDP) and a salt thereof. Among those compounds, alkali metal salts of ethylene diamine tetraacetic acid can be preferably used because they are compounds that do not promote the scale formation on the heat-transfer surface. Further, among the alkali metal salts of ethylene diamine tetraacetic acid, ethylene diamine tetraacetic acid disodium salts are particularly preferably used because they are compounds that can be safely used as food additives.

By the way, the determination kit is used for quantitatively determining the concentration of the chelating agent (e.g., EDTA) in a water sample by titrimetry. The determination kit includes a first container in which a first chemical solution containing a metal indicator is reserved, a second container in which a second chemical solution containing a pH adjuster is reserved, and a third container in which a third chemical solution containing a metal salt that changes color of the metal indicator is reserved.

The first, second, and third containers are configured to reserve their respective chemical solutions and allow them to be dropped into a water sample, for instance, which may be dropping bottles having nozzles (e.g., bottles made of a resin and attached with nozzles, respectively). The dropping bottle having a nozzle may be of a type in which the body of the bottle is squeezed when used to gradually drop a given amount of the chemical solution. Furthermore, each of the first, second, and third containers may be a dropping bottle having a dropper, for example, one having a dropper on its cap portion. The bottle with a dropper is of a type in which a chemical solution in the bottle is drawn up by the dropper when used and a given amount of the chemical solution is then gradually dropped. Furthermore, a container having a dropper provided apart from a bottle can be used for each of the first, second, and third containers. The container with a dropper is of a type in which the chemical solution in the bottle is drawn up by the dropper when used and a given amount of the chemical solution is then gradually dropped.

The bottle is desirably made of a material (e.g., polyethylene or glass) that does not release any impurity and may be also protected from light from the viewpoint of preventing the first, second, and third chemical solutions from contamination or deterioration. In addition, the capacity of the bottle is preferably set to in the range of 25 to 100 ml from the viewpoint of easiness of handling and easiness of transportation.

Now, the first, second, and third chemical solutions will be described. First, the first chemical solution will be described. The metal indicator contained in the first chemical solution is a pigment-based chelating substance that can change its color by reacting with the metal salt contained in the third chemical solution and is used for detecting the end of a titration operation. In the titration operation using the chelating agent as a target of quantitative determination, a metal ion that constitutes the metal salt (hereinafter, referred to as a “specific metal ion” for distinguishing from any metal ions in a water sample) should be dominantly complexed with the chelating agent. Thus, the metal indicator can be selected from chelating substances having smaller stability constant to the specific metal ion, compared with the chelating agent. Those chelating substances may include, when the target of quantitative determination is EDTA, xylenol orange (chemical name: 3,3′-bis[N,N-di(carboxymethyl)aminomethyl]-o-cresol sulfophthalein, disodium salt) and methyl thymol blue (chemical name: 3,3′-bis[N,N-di(carboxymethyl)aminomethyl]thymol sulfophthalein, disodium salt).

The content of the metal indicator in the first chemical solution is not particularly limited because the addition of the first chemical solution to a water sample is operated so that a given amount of the metal indicator can be supplied as described later. In general, from the view point of solubility and economy, it can be appropriately set in the range of 0.1 to 0.6% by weight.

In addition, the first chemical solution may contain a masking agent for enclosing ferrous and copper ions in a water sample. In general, the ferrous and copper ions originated from water to be supplied, a piping material, or the like are strongly complexed with the chelating agent. Therefore, the ferrous and copper ions are hardly replaced with the specific metal ions, so it takes a long period of time to determine the end of the titration operation. Meanwhile, when the first chemical solution contains the masking agent, the ferrous and copper ions are dominantly complexed with the masking agent. On this account, the whole amount of the chelating agent is quickly complexed with the specific metal ion and a reaction time required for the water sample to change its color is shortened. Here, the masking agent is selected from chelating substances having larger stability constant to ferrous and copper ions, compared with the above-mentioned chelating agent and having no inhibitory effect on identification of a change in hue of the metal indicator when the masking agent encloses ferrous and copper ions. For instance, o-phenanthroline may be used as such a chelating substance when EDTA is a target of qualitative determination.

The content of the masking agent in the first chemical solution is not particularly limited because the addition of the first chemical solution to a water sample is operated so that a given amount of the making agent can be supplied as described later. In general, from the view point of solubility and economy, it can be appropriately set in the range of 0.5 to 5% by weight.

For preventing the metal indicator from forming a complex with a ferric ion in water sample to cause a change in its color, the first chemical solution can contain a reducing agent. For instance, xylenol orange in an acidic solution is yellow at a pH of 6 or less but changes to blue when complexed with a ferric ion. As a result, a normal change in hue does not occur during the titration operation and the quantitative determination of the chelating agent becomes impossible. In contrast, when a ferric ion is reduced to a ferrous ion, xylenol orange shows its original hue. Here, the reducing agent is selected from reducing substances that reduce a ferric ion to a ferrous ion and do not produce turbidity, precipitation, and coloration in a water sample. Examples of the reducing substances include ascorbic acid and an alkali metal salt thereof, an alkali metal salt of sulfurous acid, an alkali metal salt of bisulfurous acid, and hydroxylamine chloride.

The content of the reducing agent in the first chemical solution is not particularly limited because the addition of the first chemical solution to the water sample is operated so that a given amount of the reducing agent can be supplied as described later. In general, from the view point of solubility and economy, it can be appropriately set in the range of 0.1 to 10% by weight.

The first chemical solution can be prepared by uniformly dissolving the metal indicator and other additives (the masking agent and the reducing agent) in a solvent such as water or alcohol. For instance, the first chemical solution of which target of quantitative determination is EDTA can be prepared such that xylenol orange is dissolved in water and the resultant solution is then added and mixed with o-phenanthroline dissolved in an alcohol or added and mixed with powdery ascorbic acid.

Next, the second chemical solution will be described. The pH adjuster contained in the second chemical solution is used for adjusting the water sample to an acidic region where the metal indicator can intensively change its color. In general, the pH adjuster to be used may be a buffer made of an acid or made of an acid and a salt thereof. Acids which can be used herein include inorganic acid such as nitric acid, hydrochloric acid, and sulfuric acid and organic acids such as acetic acid. In addition, the salts of the acids which can be used herein include alkali metal salts of nitric acid, hydrochloric acid, sulfuric acid, acetic acid, and the like. Two or more of the acids or the salts thereof may be used in combination.

The content of the pH adjuster in the second chemical solution is not particularly limited because the addition of the second chemical solution to the water sample is operated so that the pH of the water sample after the addition can be within a predetermined range as described later. In general, from the view point of securing the safety in handling, it is preferably a content that does not fall into deleterious substances. In addition, when the water treating agent contain an alkali metal hydroxide, the water sample is in an alkaline region. Thus, the water sample preferably contains an acid as the pH adjuster in an amount which can adjust the water sample to neutral and acidic regions.

In addition, the second chemical solution can contain the masking agent for enclosing ferrous and copper ions in the water sample. In general, the masking agent is contained in either of the first and second chemical solutions. The content of the masking agent in the second chemical solution is not particularly limited because the addition of the second chemical solution to the water sample is operated so that a given amount of the making agent can be supplied as described later. In general, from the view point of solubility and economy, it can be appropriately set in the range of 0.5 to 5% by weight.

The second chemical solution can be prepared by uniformly dissolving the pH adjuster and another additive (the masking agent) in a solvent such as water or alcohol. For instance, the second chemical solution of which target of quantitative determination is EDTA can be prepared such that nitric acid is dissolved in water and the resultant solution is then added and mixed with o-phenanthroline dissolved in an alcohol.

Next, the third chemical solution will be described. The metal salt contained in the third chemical solution is used for supplying the specific metal ion to a water sample added with the first and second chemical solutions. The metal salt can be selected from inorganic salts of multivalent metals capable of supplying the specific ion that dominantly forms a complex with the chelating agent and then allows the metal indicator to change to a certain hue. As such an inorganic salt of multivalent metal, for example, bismuth nitrate can be used when the metal indicator is xylenol orange. Here, the water sample added with xylenol orange is yellow at a pH of 6 or less but changes to red when xylenol orange is complexed with a bismuth ion, thereby, on the basis of such a change in hue, concluding that it reaches the end of the titration operation at this moment. The water sample shows orange color instead of the yellow color when o-phenanthroline (that is, the masking agent), which has enclosed ferrous and copper ions in the water sample, is coexisted. However, the water sample changes to red when xylenol orange forms a complex with the bismuth ion. Therefore, on the basis of such a change in hue, the end of the titration operation is determined.

The content of the metal salt in the third chemical solution is set on the basis of resolution of the quantitative value of the chelating agent. In other words, the content of the melt salt is adjusted in advance so that the metal salt contained in one droplet of the third chemical solution discharged from the nozzle or the dropper can react with a given amount of the chelating agent. For instance, under the conditions in which the water sample is 10 ml and the volume of one droplet of the second chemical solution discharged from the nozzle or the dropper is 0.035 g, the content of bismuth nitrate is set to 0.168% by weight when free or complexed EDTA in the water sample is quantitatively determined as EDTA-2Na with a resolution corresponding to 0.05 mg/droplet.

In addition, the third chemical solution can contain a surface tension depressant so that the third chemical solution can be discharged from the nozzle or dropper in a constant volume per droplet. For instance, a larger volume of the third chemical solution is discharged when the body of the dropping bottle with the nozzle is slowly squeezed in comparison with being squeezed quickly. In contrast, when the third chemical solution contains the surface tension depressant, a surface tension at the tip of the nozzle decreases and a constant volume discharged per droplet can be thus attained. Here, the surface tension depressant is selected from substances that act to lower the surface tension of an aqueous solution and does not react with the metal salt. The substances which can be used include alcohol compounds and non-ionic surfactants. Preferable examples of the alcohol compounds include glycols such as ethylene glycol and propylene glycol. In addition, preferable examples of the non-ionic surfactants include polyoxyethylene alkyl ethers and polyalkylene alkyl ethers.

The content of the surface tension depressant in the third chemical solution is preferably set to 20 to 40% by weight from the viewpoint of limiting a variation in volume discharged per droplet within ±5% or less.

The third chemical solution can be prepared by uniformly dissolving the metal salt and another additive (the surface tension depressant) in a solvent such as water or a dilute acid. For instance, the third chemical solution of which target of quantitative determination is EDTA can be prepared such that bismuth nitrate is dissolved in dilute nitric acid and, if required, propylene glycol or the like is dissolved in the resultant solution.

The determination kit may be configured such that the first chemical solution does not contain the reducing agent and a fourth container reserving the powdery reducing agent is provided in addition to the first, second, and third containers. Depending on the types of the reducing agents, some of them are apt to undergo oxidation with time when they are stored in an aqueous solution, so they may stand up to a short-term storage of 1 to 3 months but a long-term storage of one year. When the reducing agent having such a property is used, the reducing agent in powdered form may be directly stored in the fourth container to store the reducing agent over a long-term period.

Any kind of the fourth container can be used as far as it is a container of a type which can prevent air oxidation by an airtight stopper. In addition, the capacity of the fourth container is preferably set to 25 to 100 ml from the viewpoint of easiness of handling and easiness of transportation. More preferably, the fourth container may be provided with a measuring spoon. Having the measuring spoon allows a maintainer or a user to measure off a given amount of the reducing agent and then add it to a water sample, thereby increasing operability.

Next, a determination method for the chelating agent using the determination kit will be described. First, a part of water reserved in the thermal equipment is collected as a water sample. When the thermal equipment is a boiler, the water sample may be a part of boiler water being collected using a blower or the like. Alternatively, the water sample may be a part of circulating water being collected using a sparging apparatus or the like when the thermal equipment is a cooling tower. Here, when the collected water sample is at a temperature of more than 40° C., it is preferable to cool the water sample to 40° C. or less from the viewpoint of securing safety in a titration operation. In addition, when the collected water sample is turbid, the water sample is preferably filtrated from the viewpoint of accurately identifying a change in hue of the water sample in a titration operation. For subjecting the collected water sample to a titration operation, a given amount of the water sample (e.g., 10 to 50 ml thereof) may be fractionated using a measuring cylinder in advance and then transferred into a beaker.

Subsequently, the first chemical solution is added to the collected water sample and then uniformly mixed. The amount of the first chemical solution to be added is adjusted in number of droplets from the first container so that, in general, 0.0001 to 0.003 parts by weight of the metal indicator and 0.001 to 0.5 parts by weight of the reducing agent are respectively added with respect to 100 parts by weight of the water sample. Furthermore, the second chemical solution is added to the water sample and uniformly mixed. The amount of the second chemical solution to be added is adjusted in number of droplets from the second container so that, in general, the pH adjuster is added in an amount enough to allow the pH of the water sample to be 6 or less, more preferably 1 to 3 at which adverse effects of divalent metal ions and rare-earth metal ions are apt to be avoided. Furthermore, when the first or second chemical solution contains the masking agent, the number of droplets from the first or second container is adjusted so that 0.005 to 0.5 parts by weight of the masking agent can be added. The order of the addition of first and second chemical solutions is not particularly limited and they may be simultaneously added.

Here, when the amount of the metal indicator to be added is less than 0.0001 parts by weight, the water sample is lightly colored, resulting in difficulty of identifying a change in hue near the end of the titration operation. In contrast, when the amount of the metal indicator to be added exceeds 0.003 parts by weight, the water sample is strongly colored, resulting in difficulty of identifying a change in hue near the end of the titration operation. Furthermore, when the amount of the reducing agent to be added is less than 0.001 parts by weight, there is a possibility that the whole amount of the ferric ion in the water sample cannot be reduced. On the other hand, when the amount of the reducing agent exceeds 0.5 parts by weight, an excess part of the reducing agent does not contribute to the reduction of the ferric ion, so it may be at a risk of being uneconomical. In addition, when the pH of the water sample exceeds 6, the metal indicator may not show a predetermined hue. Furthermore, when the amount of the masking agent to be added is less than 0.005 parts by weight, the whole amount of ferrous and copper ions in the water sample cannot be enclosed, so an accurate quantitative value may not be obtained. On the other hand, when the amount of the masking agent exceeds 0.5 parts by weight, an excess part of the masking agent does not contribute to enclosure of ferrous and copper ions, so it may be at a risk of being uneconomical.

In the step of adding the first chemical solution, when the first chemical solution is prepared so that it does not contain the reducing agent, the powdery reducing agent from the fourth container is generally added to the water sample and then uniformly mixed just before the addition of the first chemical solution. The amount of the reducing agent to be added at this time is adjusted to, just as in the case of adding the reducing agent to the first chemical solution, 0.001 to 0.5 parts by weight with respect to 100 parts by weight of the water sample.

When the first chemical solution containing the reducing agent or the powdery reducing agent is added to the water sample, a ferric ion in the water sample is reduced to a ferrous ion. Subsequently, the ferrous ion is dominantly complexed with the masking agent. Consequently, the metal indicator, such as xylenol orange, is prevented from changing its color by the formation of a complex with ferric ion, so the water sample can retain its normal hue.

Next, the third chemical solution from the third container is dropped into the water sample added with the first and second chemical solutions and the number of droplets required to change the color of the water sample is then counted. At this time, the third chemical solution is dropped while shaking the beaker so that the water sample and the third chemical solution are uniformly mixed.

When the third chemical solution is gradually dropped into the water sample added with the first and second chemical solutions, the chelating agent is dominantly complexed with the specific metal ion. Subsequently, when the whole amount of the chelating agent is complexed with the specific metal ion, the metal indicator is then complexed with the redundant specific metal ion, thereby causing a change in color of the water sample. For instance, when the chelating agents are EDTA and an alkali metal salt thereof, dropping the third chemical solution into the water sample added with the first and second chemical solutions allows EDTA to dominantly form a complex with a bismuth ion. Subsequently, when the whole amount of EDTA is complexed with the bismuth ion, xylenol orange is then complexed with the redundant bismuth ion, thereby changing the color of the water sample from yellow (or orange when coexistent with o-phenanthroline bound to ferrous ion) to red.

Furthermore, when the third chemical solution is dropped into the water sample in the presence of the masking agent, the ferrous and copper ions being complexed with the chelating agent are dominantly complexed with the masking agent. Therefore, the whole amount of the chelating agent is quickly complexed with the specific metal ion, thereby shortening a reaction time until the water sample changes its color.

Next, on the basis of the number of droplets of the third chemical solution, which has required until the end of the titration operation, the concentration of the chelating agent in the water sample is determined. As described above, as the third chemical solution is prepared so that the metal salt in one droplet can react with a given amount of the chelating agent, the concentration of the chelating agent in the water sample can be calculated from the corresponding amount of the chelating agent per droplet of the third chemical solution, the number of droplets of the third chemical solution, and the fractional amount of the water sample.

By the way, in the thermal equipment, the chelating agent is being dissolved in water in a free state or in a state of being complexed with a hardness component. In general, water reserved in the thermal equipment is intermittently blown or periodically supplied with refill water so that the predetermined concentration rate is maintained. Therefore, the chelating agent does not exist in an amount exceeding solubility thereof so that the chelating agent is free from the possibility of being crystallized in water or being deposited on the heat-transfer surface. From the reasons, the concentration of the chelating agent in the thermal equipment correlates with the concentration of a water treating agent, so the concentration of the water treating agent can be easily determined from the concentration of the chelating agent and the blending ratio of the chelating agent to the water treating agent. Therefore, on the basis of the concentration of the water treating agent, it is possible to judge whether the supply amount of the water treating agent is suitable.

As described above, according to the embodiments of the present invention, the concentration of a water treating agent can be simply understood on site where thermal equipment is placed. Consequently, it is possible to judge whether the supply amount of the water treating agent to the thermal equipment is suitable on the site, so the maintenance of water treatment can be made more efficient.

### EXAMPLES

### (Preparation of First Chemical Solution)

A first chemical solution was prepared using xylenol orange as a metal indicator, o-phenanthroline as a masking agent, and distilled water and ethanol as solvents, the respective components being mixed in contents as represented in Table 1. After the preparation, the first chemical solution was loaded in a dropping bottle with a nozzle made of polyethylene (100 ml in capacity; hereinafter, referred to as a “first container”). The dropping amount of the first chemical solution per droplet from the first container was 0.035 g (in average).

TABLE 1

| Component | Content (% by weight) |
|---|---|
| Xylenol orange | 0.3 |
| o-phenanthroline | 2 |
| Distilled water | 77.7 |
| Ethanol | 20 |

### (Preparation of Second Chemical Solution)

A second chemical solution was prepared using a 10% aqueous nitric acid solution as a pH adjuster. The second chemical solution was loaded in a dropping bottle with a nozzle made of polyethylene (100 ml in capacity; hereinafter, referred to as a “second container”). The dropping amount of the second chemical solution per droplet from the second container was 0.035 g (in average).

### (Preparation of Third Chemical Solution)

A third chemical solution was prepared using bismuth nitrate pentahydrate as a metal salt and a 0.5 mol/l aqueous nitric acid solution as a solvent, the respective components being mixed in contents as represented in Table 2. After the preparation, the third chemical solution was loaded in a dropping bottle with a nozzle made of polyethylene (100 ml in capacity; hereinafter, referred to as a “third container”). The dropping amount of the third chemical solution per droplet from the third container was 0.035 g (in average). One droplet of the third chemical solution corresponded to 0.05 mg of EDTA-2Na.

TABLE 2

| Component | Content (% by weight) |
|---|---|
| Bismuth nitrate pentahydrate | 0.21 |
| 0.5 mol/l aqueous nitric acid | 99.79 |
| solution | |

### (Collection of Water Sample)

Among throw-flow boilers each supplying a water treating agent mixed with ethylene diamine tetraacetic acid disodium (EDTA-2Na) as a scale inhibitor, 67 boilers around Japan were randomly extracted and water samples were then collected from the respective continuous blowers in operation. The water treating agent was blended with an alkali metal hydroxide as a corrosion inhibitor in addition to EDTA-2Na. The collected water samples had pH values in the range of 10.5 to 12, respectively. Each of the water samples was cooled to room temperature and a 10-ml aliquot thereof was then taken into a beaker using a measuring cylinder, thereby preparing a first fractionated water sample for each of the 67 samples. In addition, from each of the water samples, a 5-ml aliquot thereof was taken into a beaker using a measuring cylinder, thereby preparing a second fractionated water sample for each of the 67 samples.

### (Determination of EDTA with Simple Titrimetry)

Twenty milligrams of powdery ascorbic acid was added to the first fractionated water sample and then uniformly dissolved therein. One drop of the first chemical solution from the first container and then five droplets of the second chemical solution from the second container were added to the first fractionated water sample added with the reducing agent, followed by uniformly mixing them to prepare a test solution. Subsequently, in the test solution, the third chemical solution was dropped from the third container and the number of droplets was then counted until the test solution changes its color from orange to red. Then, the concentration of EDTA-2Na in the water sample was calculated from the corresponding amount of EDTA-2Na per droplet of the third chemical solution, the number of droplets of the third chemical solution, and the fractional amount of water sample. In the operation described above, the time period taken to determination per sample was 1 to 3 minutes.

### (Determination of EDTA Using High-Performance Liquid Chromatography)

For comparing with a quantitative value of EDTA obtained by simple titrimetry, determination of EDTA with high-performance liquid chromatography (HPLC) was conducted on the second fractionated water sample. First, a commercially available 0.01 mol/l aqueous ethylene diamine tetraacetic acid disodium (EDTA-2Na) solution was diluted with distilled water to prepare standard solutions of 0 mg/l, 10 mg/l, 20 mg/l, 40 mg/l, and 80 mg/l. Furthermore, 0.27 g of ferric chloride hexahydrate was dissolved in 0.01 N hydrochloric acid and a total volume was adjusted to 100 ml, thereby preparing a 0.01-mol/l ferric chloride solution.

Five milliliters of the 0.01-mol/l ferric chloride solution was added to 5 ml of each of the standard solutions and each of the resultant mixtures was then filtrated through a membrane filter of 0.2 μm in pore size, followed by subjecting a 10-μl aliquot of each solution to high-performance liquid chromatography. Subsequently, for each solution, a standard curve was created from the resultant peak height and concentration. Here, the conditions of high-performance liquid chromatography were as follows:

Dimensions of column: 4.6 mm in inner diameter and 150 mm in length;

Stationary phase: whole-porous silica gel chemically modified with an octadecyl group;

Mobile phase: 0.01 mol/l tetra-n-butylammonium hydroxide solution with pH 3.0 adjusted by addition of acetic acid;

Flow rate of mobile phase: 1.0 ml/min.;

Selected wavelength of detector: 255 nm.

Next, 5 ml of the 0.01-mol/l ferric chloride solution was added to the second fractionated water sample, and the mixture was then filtrated through a membrane filter of 0.2 μm in pore side, followed by subjecting a 10-μl aliquot of each solution to high-performance liquid chromatography under the same conditions as that of the standard solution, to determine a peak height. Subsequently, the concentration of EDTA-2Na in the water sample was calculated on the basis of a standard curve previously created. In the above operation, the time taken to determination per sample was 25 minutes.

### (Evaluation)

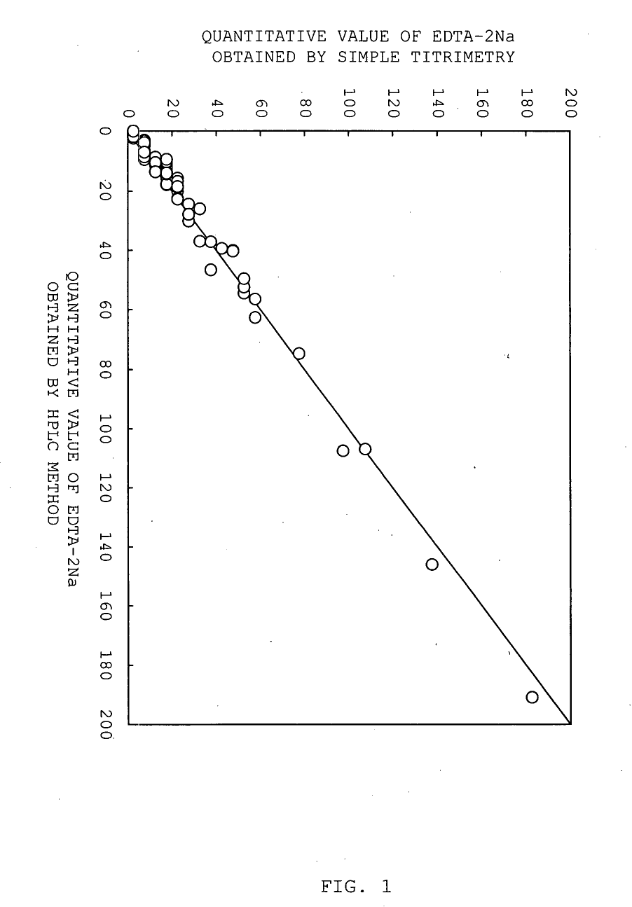

For each water sample, FIG. 1 represents a graph in which quantitative values obtained by the simple titrimetry are plotted with respect to the quantitative values obtained by the HPLC method. According to FIG. 1, the quantitative values obtained by the simple titrimetry may have a difference of about 5 mg/l on the plus side with respect to the quantitative values obtained by the HPLC method. This is because the resolution of the quantitative values obtained by the simple titrimetry is set to 5 mg/l. It was found that the quantitative values obtained by the simple titrimetry have high reliabilities because of a substantial linear correlation with those obtained by the HPLC method. In addition, the simple titrimetry is capable of carrying out determination at short periods of time without using any special equipment, so it can be effective for determination at site.

What is claimed is:

1. A method of determining a concentration of a chelating agent in a water sample, comprising the steps of:
collecting a water sample;
adding a first chemical solution containing a metal indicator and a second chemical solution containing a pH adjuster to the collected water sample, respectively;
dropping a third chemical solution which contains a metal salt that causes a change in color of the metal indicator into the water sample added with the first chemical solution and the second chemical solution, followed by counting the number of droplets required for the water sample to change color thereof; and
determining a concentration of a chelating agent in the water sample on the basis of the number of droplets of the third chemical solution.

2. A method of determining a chelating agent according to claim 1, further comprising the step of adding a masking agent to the collected water sample.

3. A method of determining a chelating agent according to claim 2, further comprising the step of adding a reducing agent to the collected water sample.

4. A method of determining a concentration of a chelating agent in a water sample, comprising the steps of:
collecting a water sample;
adding a first chemical solution containing a metal indicator and a second chemical solution containing a pH adjuster to the collected water sample, respectively;
dropping a third chemical solution which contains a metal salt that causes a change in color of the metal indicator into the water sample added with the first chemical solution and the second chemical solution, followed by counting the number of droplets required for the water sample to change color thereof; and
determining a concentration of a chelating agent in the water sample on the basis of the number of droplets of the third chemical solution, wherein
the chelating agent is at least one of ethylene diamine tetraacetic acid and a salt thereof, the metal indicator is xylenol orange, the pH adjuster is nitric acid, and the metal salt is bismuth nitrate.

5. A method of determining a chelating agent according to claim 4, further comprising the step of adding a masking agent to the collected water sample, wherein the masking agent is o-phenanthroline.

6. A method of determining a chelating agent according to claim 5, further comprising the step of adding a reducing agent to the collected water sample, wherein the reducing agent is at least one of ascorbic acid and an alkaline metal salt thereof.

7. A kit for quantitatively determining a concentration of a chelating agent in a water sample, comprising:
a first container that reserves a first chemical solution containing a metal indicator;
a second container that reserves a second chemical solution containing a pH adjuster; and
a third container that reserves a third chemical solution containing a metal salt that causes a change in color of the metal indicator.

8. A kit for determining a chelating agent according to claim 7, wherein any one of the first chemical solution and the second chemical solution further contains a masking agent.

9. A kit for determining a chelating agent according to claim 8, wherein the first chemical solution further contains a reducing agent.

10. A kit for determining a chelating agent according to claim 8, further comprising a fourth container that reserves a powdery reducing agent.
